(19) United States
(12) Patent Application Publication
(10) Pub. No.: US 2005/0089790 A1
(43) Pub. Date: Apr. 28, 2005

(54) Photoresist composition for a spinless coater and method of forming a photoresist pattern using the same

(75) Inventors: Dong-Ki Lee, Seoul (KR); Jin-Ho Ju, Seoul (KR); Hyo-Youl Kim, Suwon-si (KR)

Correspondence Address: MacPherson Kwok Chen & Heid LLP;Suite 226, 1762 Technology Drive, San Jose, CA, 95110, US

(73) Assignee: SAMSUNG ELECTRONICS CO., LTD., Suwon-si (KR)

(21) Appl. No.: 10/931,387

(22) Filed: Sep. 1, 2004

(30) Foreign Application Priority Data
Sep. 2, 2003 (KR) 2003-60969

(51) Int. Cl. G03C 5/18

(52) U.S. Cl. 430/141

(57) ABSTRACT

A photoresist composition for a spinless coater includes a novolak resin having a weight average molecular weight of about 2,000 to about 15,000, a diazide based photosensitive compound and a volatile organic solvent. The photoresist composition is applied to a substrate of a liquid crystal display apparatus to reduce blots and enhance application uniformity. A highly volatile solvent, such as n-propyl acetate (nPAC) or n-butyl acetate (nBA) is used in the photoresist composition as the volatile organic solvent. The photoresist composition including the volatile organic solvent gives a photoresist film that has a uniform thickness. Hence, the generation of small resin blots and thick blots may be reduced.

### CROSS-REFERENCE TO RELATED APPLICATIONS

This application relies for priority upon Korean Patent Application No. 2003-60969 filed on Sep. 2, 2003, the contents of which are herein incorporated by reference in its entirety.

### BACKGROUND OF THE INVENTION

1. Field of the Invention

The present invention relates to a photoresist composition for a spinless coater and a method of forming a photoresist pattern using the photoresist composition. More particularly, the present invention relates to a photoresist composition having modified solvent formulation for a large substrate and a method of forming a photoresist pattern using the photoresist composition.

2. Description of the Related Art

A liquid crystal display apparatus is widely used in various fields such as a notebook computer, a personal digital assistant (PDA), a television receiver set or a monitor for an airplane with its low operation voltage, low power consumption characteristic, full color displaying ability and thin appearance. Recently, as a display panel of the liquid crystal display apparatus has become larger, a high pitch liquid crystal display apparatus has been required.

Generally, many failures in the process of manufacturing the liquid crystal display apparatus occur during photolithography processes that use photoresist compositions. When the photoresist composition is not uniformly applied to a substrate, the resolution, circuit width or reflectivity of the liquid crystal display apparatus becomes irregular, thereby causing failures in subsequent processes.

Moreover, as it has been required to reduce the time for applying the photoresist composition, there have been developed a method of applying a photoresist composition in a short time and a composition that may be used for this method.

Regarding the methods of applying the photoresist composition, a roll coating method or a spin coating method may be mentioned. In the roll coating method, the photoresist composition is applied to a substrate by a roll having the photoresist composition loaded. In the spin coating method, the photoresist composition is dropped onto a rotating substrate and the photoresist composition is spread uniformly toward outside of the substrate by a centrifugal force.

Generally, the photoresist composition includes a novolak resin and a photoinitiator dissolved in an organic solvent. Usually, the novolak resin includes a photoreactive polymer resin, and the photoinitiator includes a diazide-based photosensitive compound.

The novolak resin preferably has a certain range of molecular weight to obtain a desired thickness in forming a photoresist pattern using the photoresist compound. In addition, the photoresist compound preferably has a suitable viscosity to improve coating characteristics.

Korean Patent Laid-Open Publication Nos. 2002-10291, 2002-76724, and 2003-35478 and Japanese Patent Laid-Open Publication No. 1995-140647 disclose photoresist compositions having novolak resins, diazide based photosensitive compounds and organic solvents and methods of applying the same.

In particular, Korean Patent Laid-Open Publication No. 2002-10291 discloses a photoresist composition that is suitable for a dipping, spraying, rotating or spin coating method. The photoresist composition has an organic solvent including a mixture of propylene glycol methyl ether acetate (PGMEA) and methyl methoxy propionate (MMP). The photoresist composition, however, is not uniformly coated on a large substrate resulting in an uneven photoresist film. Moreover, the photoresist composition has low volatility, thereby causing blots that are not suitable for a large substrate.

Korean Patent Laid-Open Publication No. 2002-76724 discloses a composition that is used for a dipping, spraying or spin coating method. The photoresist composition has an organic solvent including a mixture of propylene glycol methyl ether acetate (PGMEA) and ethyl lactate (EL). The photoresist composition, however, is not uniformly coated on a large substrate resulting in an uneven photoresist film. Moreover, the photoresist composition has low volatility, thereby causing blots that are not suitable for a large substrate.

A photoresist composition disclosed in Korean Patent Laid-Open Publication No. 2003-35478 is used for a dipping, spraying, rotating or spin coating method. The photoresist composition has an organic solvent at least one selected form the group consisting of propylene glycol methyl ether acetate (PGMEA), ethyl lactate (EL), methyl methoxy propionate (MMP) and propylene glycol monomethyl ether (PGME). The photoresist composition, however, is not uniformly coated on a large substrate, so that an uneven photoresist film is formed. Moreover, the photoresist composition has low volatility, thereby causing blots that are not suitable for a large substrate.

A photoresist composition disclosed in Japanese Patent Laid-Open Publication No. 1995-140647 is used for a roll coating or spin coating method. The photoresist composition has an organic solvent including a mixture of 2-oxy propionic acid alkyls and propylene glycol alkyl ether acetate. The photoresist composition, however, is not uniformly coated on a large substrate, so that an uneven photoresist film is formed. Moreover, the photoresist composition has low volatility, thereby causing blots that are not suitable for a large substrate.

Korean Patent Laid-Open Publication No. 1994-917 discloses a photoresist composition including a novolak resin and a diazide based photosensitive compound. The photoresist composition has a viscosity that is relatively high for a semiconductor circuit. Thus, the photoresist composition may not be used for a substrate of a large liquid crystal display apparatus.

When the conventional photoresist compositions are used for a spin coating method or a roll coating method for manufacturing a high pitch liquid crystal display apparatus having a large substrate, the conventional photoresist compositions are not uniformly formed and blots may be generated. Thus, a photoresist pattern is not formed in a precise and regular manner, causing to deteriorate the display quality of the liquid crystal display apparatus.

### SUMMARY OF THE INVENTION

Accordingly, the invention is provided to substantially obviate one or more problems due to limitations and disadvantages of the related art.

The present invention provides a photoresist composition for a liquid crystal display apparatus having a large substrate that may be uniformly applied and gives few blots.

The present invention also provides a method of forming a photoresist pattern of a liquid crystal display apparatus using the photoresist composition.

According to an exemplary photoresist composition for a spinless coater, the photoresist composition includes a novolak resin having a weight average molecular weight of about 2,000 to about 15,000, a diazide based photosensitive compound and a volatile organic solvent.

According to an exemplary method of forming a photoresist pattern, a photoresist composition for a spinless coater is applied to an underlying layer by a spinless coating method to form a photoresist film. The photoresist composition includes a novolak resin having a weight average molecular weight of about 2,000 to about 15,000, a diazide based photosensitive compound and a volatile organic solvent. Then, the photoresist film is exposed and developed to form a photoresist pattern.

In the photoresist composition and the method of forming a photoresist pattern using the photoresist composition, a highly volatile organic solvent is used. Thus, the thickness of a photoresist film formed from the photoresist composition is uniform and few blots are generated. Hence, the photoresist composition may be used for a high pitch liquid crystal display apparatus having a large substrate. Moreover, since a spinless coating method is used, a manufacturing cost and a processing time may be reduced.

### BRIEF DESCRIPTION OF THE DRAWINGS

The above and other features and advantage points of the invention will become more apparent by describing in detailed exemplary embodiments thereof with reference to the accompanying drawings, in which:

FIG. 1 is a perspective view illustrating a method of applying a photoresist composition according to an embodiment of the invention using a spinless coater.

FIG. 2A is an electron microscope picture illustrating a thick blot formed on a display panel.

FIG. 2B is an electron microscope picture illustrating a large resin blot and small resin blot formed on a display panel.

FIGS. 3A and 3B are cross-sectional views illustrating a method of forming a photoresist pattern according to an embodiment of the invention.

### DESCRIPTION OF INVENTION

Hereinafter, the preferred embodiment of the invention will be described in detail with reference to the accompanied drawings.

Spinless Coating Method

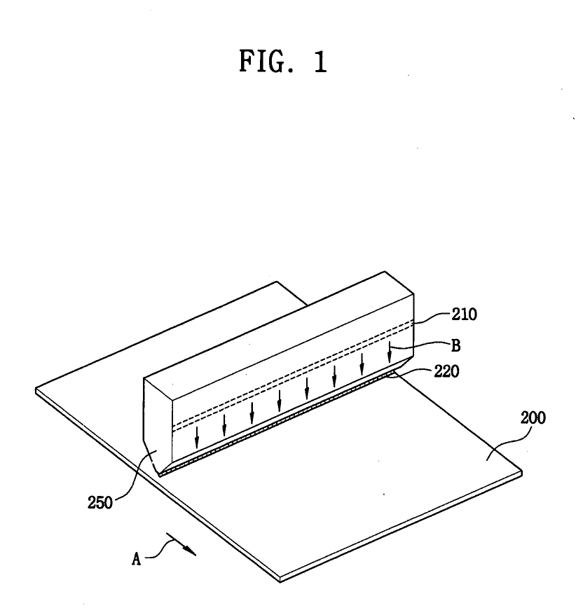

A method of coating a substrate without using a spinner (hereinafter, referred to as ‘spinless coating method’) is one of the methods of coating a photoresist composition to a large substrate. In the spinless coating method, the photoresist composition is coated to the substrate through a nozzle moving in a certain direction. The spinless coating method includes a method of coating the substrate using a slit (hereinafter, referred to as a ‘slit coating method’). The procedure of the spinless coating method is illustrated in FIG. 1.

FIG. 1 is a perspective view illustrating a method of applying a photoresist composition according to an embodiment of the invention using a coater without a spinner (hereinafter, referred to as a ‘spinless coater’).

Referring to FIG. 1, a photoresist composition 220 is applied to a substrate 200, while the photoresist composition 220 is discharged through a slit type nozzle 210. In FIG. 1, ‘A’ represents a direction of moving of the spinless coater 250, and ‘B’ represents a direction of discharging of the photoresist composition 220. When the slit type nozzle 210 is used, the waste of the photoresist composition 220 is greatly reduced. Moreover, the accumulation of the photoresist composition at the edge of the substrate 200 is reduced in comparison with a spin coating method. Thus, performing an edge bead removing process (or ‘EBR’ process) is not required.

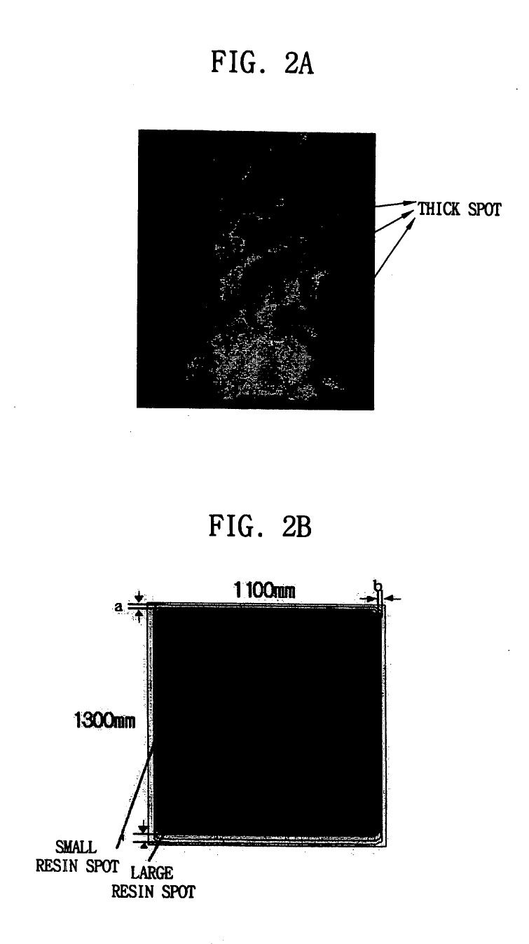

When a conventional photoresist composition is applied to a substrate by the spinless coating method, thick blots and resin blots may be generated as shown in FIG. 2A and FIG. 2B, respectively.

FIG. 2A is an electron microscope picture illustrating a thick blot formed on a display panel.

FIG. 2B is an electron microscope picture illustrating a large resin blot and a small resin blot formed on a display panel.

As depicted in FIG. 2A, the thick blot is generated in the display panel in the shape of cumulus cloud.

As shown in FIG. 2B, a small resin blot is generated at several positions of the upper portion of the display panel during the application of the photoresist composition. A large resin blot is generated along the display panel right after the application of the photoresist composition.

Hereinafter, a photoresist composition for preventing above-mentioned problems will be explained.

Photoresist Composition for Spinless Coater

A photoresist composition for a spinless coater according to the present invention includes a highly volatile organic solvent. The photoresist composition may be used in a spinless coating method that uses a slit type nozzle in a large display panel. Use of the photoresist composition enhances thickness uniformity of a photoresist film and reduces blots generated. The photoresist composition may be used for manufacturing a circuit for a high pitch liquid crystal display apparatus.

The photoresist composition for the spinless coater includes a novolak resin having a weight average molecular weight of about 2,000 to about 15,000, a diazide based photosensitive compound and a volatile organic solvent.

When the weight average molecular weight of the novolak resin is more than about 15,000, the viscosity of the photoresist composition increases, which is not preferable. When the weight average molecular weight of the novolak resin is less than about 2,000, the novolak resin is excessively used, which is not preferable either. Thus, the weight average molecular weight of the novolak resin is about 2,000 to about 15,000, preferably about 3,000 to about 12,000.

The novolak resin is represented by the following formula (I): 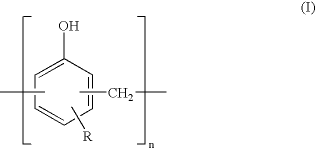
wherein ‘n’ represents an integer of 1 to 10,000, and R represents a hydrogen atom, alkyl group, alkoxy group, halogen atom or nitro group.

To produce the novolak resin, meta-aromatic compounds, para-aromatic compounds and formaldehydes are mixed and then heated. The meta-aromatic compounds increase sensitivity on a light, and the para-aromatic compounds decrease sensitivity. The amount of the photosensitive compound may be determined according to the structure of the novolak resin.

When the photoresist composition includes more than about 30% by weight of the novolak resin, a resin blot or a thick blot occurs. When the photoresist composition comprises less than about 5% by weight of the novolak resin, the residual layer characteristic is reduced, which is not preferable. Thus, the photoresist composition includes about 5 to about 30% by weight of the novolak resin. Preferably, the photoresist composition includes about 10 to about 20% by weight of the novolak resin.

Examples of the diazide based photosensitive compound include 2,3,4-trihydroxy benzophenone-1,2-naphthoquinone diazide-5-sulphonate represented by formula (□A) and 2,3,4,4′-tetrahydroxy benzophenone-1,2-naphthoquinone diazide-5-sulphonate represented by formula (□B).

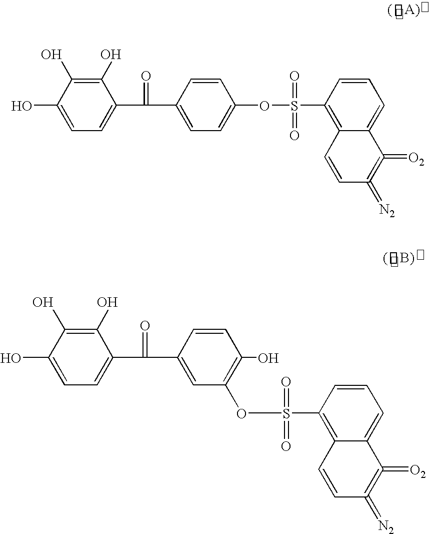

2,3,4-trihydroxy benzophenone-1,2-naphthoquinone diazide-5-sulphonate represented by formula (□A) is produced by an esterification reaction of trihydroxy benzophenone with 2-diazo-1-naphthol-5-sulfonic acid. 2,3,4,4′-tetrahydroxy benzophenone-1,2-naphthoquinone diazide-5-sulphonate of formula (□B) is produced by an esterification reaction of tetrahydroxy benzophenone with 2-diazo-1-naphthol-5-sulfonic acid.

When the photoresist composition includes more than about 10% by weight of the diazide based photosensitive compound, the photoresist composition is not deeply cured, causing to deteriorate the adhesiveness. When the photoresist composition includes less than about 2% by weight of the diazide based photosensitive compound, curing speed decreases, which is not preferable. Hence, the photoresist composition includes about 2 to about 10% by weight, preferably about 3 to about 7% by weight of the diazide based photosensitive compound.

In order to control the photochemical reaction speed using the photosensitive compound, the amount of the photosensitive compound or the degree of the esterification may be adjusted.

In the method of adjusting the amount of the photosensitive compound, when the amount of 2,3,4,4′-tetrahydroxy benzophenone-1,2-naphthoquinone diazide-5-sulphonate of formula (□B) is more than about 70% by weight, the light sensitivity is reduced. When the amount of 2,3,4,4′-tetrahydroxy benzophenone-1,2-naphthoquinone diazide-5-sulphonate of formula (□B) is less than about 30% by weight, the residual layer characteristic is reduced, which is not preferable. Thus, the mixing ratio of the diazide based photosensitive compound of formula (□A) and diazide based photosensitive compound of formula (□B) is about 30:70 to about 70:30 by weight.

In the method of adjusting the degree of esterification, the amount of sulphonate is adjusted by controlling the amounts of 2,3,4,4′-tetrahydroxy benzophenone and 2-diazo-1-naphthol-5-sulfonic acid during the esterification reaction.

The photoresist compound according to the present invention includes a volatile organic solvent for dissolving the novolak resin and the diazide based photosensitive compound.

When the photoresist composition includes more than about 90% by weight of the volatile organic solvent, the residual layer characteristic is reduced, which is not preferable. When the photoresist composition includes less than about 60% by weight of the volatile organic solvent, a resin blot or a thick blot may be generated. Thus, the photoresist composition includes about 60 to about 90% by weight of the volatile organic solvent.

As the organic solvent has higher volatility and solvent power, the surface of the photoresist film including the organic solvent becomes smoother. The solvent power indicates the ability of dissolving the novolak resin and the photosensitive compound. If the solvent has excellent solvent power, residue of solute is reduced and the resulting film becomes flat or smooth.

Volatility indicates a degree, by which the organic solvent is vaporized, when the photoresist composition is applied to a substrate and then dried. When the volatility of the organic solvent is too high, the photoresist composition is not easily applied to the substrate, and the film becomes too dry causing uneven surface. When the volatility of the organic solvent is too low, the organic solvent remains on the film resulting in failures in subsequent processes.

Since each organic solvent has an intrinsic viscosity, use of an organic solvent having too high or too low viscosity alone may deteriorate operation property.

Thus, an organic solvent having excellent solvent power, volatility and viscosity is preferably used.

Examples of the organic solvent include propylene glycol methyl ether acetate (PGMEA) of formula (□A), ethyl lactate (EL) of formula (□B), ethyl cellosolve acetate (ECA) of formula (□C), γ-butyrolactone (GBL) of formula (□D), methyl methoxy propionate (MMP) of formula (□E), propylene glycol monomethyl ether (PGME) of formula (□F), ethyl-β-ethoxypropionate (EEP) of formula (□G), n-propyl acetate (nPAC) of formula (□H), n-butyl acetate (nBA) of formula (□I):

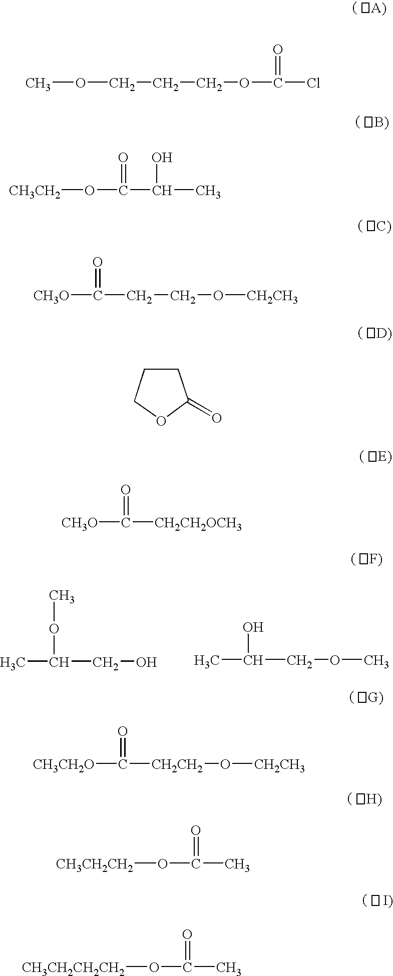

Among the organic solvents, propylene glycol methyl ether acetate (PGMEA), ethyl lactate (EL), ethyl cellosolve acetate (ECA), γ-butyrolactone (GBL), methyl methoxy propionate (MMP) and ethyl-β-ethoxypropionate (EEP) have excellent solvent power for the novolak resin but low volatility and high viscosity. On the other hands, propylene glycol monomethyl ether (PGME), n propyl acetate (nPAC) and n-butyl acetate (nBA) have excellent solvent power and low viscosity but high volatility.

The organic solvent alone may not represent excellent solvent power, excellent volatility and excellent viscosity. Hence, organic solvents of formula (□A) to (□I) are preferably mixed with each other.

Propylene glycol methyl ether acetate (PGMEA) that has an excellent residual layer characteristic is preferably mixed with n-propyl acetate (nPAC) or n-butyl acetate (nBA). Ethyl-β-ethoxypropionate (EEP) that imparts mobility to the photoresist composition and enhances smoothness is preferably mixed with propylene glycol methyl ether acetate (PGMEA). Thus, two-part or three-part volatile organic solvent may be used.

Examples of the two-part volatile organic solvent include a first solvent such as n-butyl acetate (nBA), n-propyl acetate (nPAC) or ethyl-β-ethoxypropionate (EEP) and a second solvent such as propylene glycol methyl ether acetate (PGMEA).

When the two-part volatile organic solvent includes more than about 50% by weight or less than about 5% by weight of the first solvent, the balance of the solvent power, viscosity and volatility is deteriorated. When the two-part volatile organic solvent includes more than about 95% by weight or less than about 50% by weight of the second solvent, the balance of the solvent power, viscosity and volatility is deteriorated. Hence, the mixing ratio of the first solvent and the second solvent is preferably from about 5:95 to about 50:50 by weight.

Examples of the three-part volatile organic solvent include a mixture of ethyl-β-ethoxypropionate (EEP) and propylene glycol methyl ether acetate (PGMEA) with n-propyl acetate (nPAC) or n-butyl acetate (nBA).

The three-part volatile organic solvent includes a third solvent such as n-butyl acetate (nBA) or n-propyl acetate (nPAC), a fourth solvent such as ethyl-β-ethoxypropionate (EEP) and a fifth solvent such as propylene glycol methyl ether acetate (PGMEA).

When the three-part volatile organic solvent includes more than about 25% by weight or less than about 5% by weight of the third solvent, the balance of the solvent power, viscosity and volatility is deteriorated. When the three-part volatile organic solvent includes more than about 25% by weight or less than about 5% by weight of the fourth solvent, the balance of the solvent power, viscosity and volatility is deteriorated. When the three-part volatile organic solvent includes more than about 90% by weight or less than about 50% by weight of the fifth solvent, the balance of the solvent power, viscosity and volatility is deteriorated. Thus, the mixing ratio of the third, fourth and fifth solvent is about 5˜25: 5∞25:90˜50 by weight.

The viscosity of the solid content of the composition is advantageously from about 3.0 to about 10.0 cP.

The photoresist composition according to the invention may further include a silicon based additive for reducing blots and improving coating characteristics of application. The silicon based additive serves as a surfactant.

Examples of the surfactant include polyoxyalkylene dimethylpolysiloxane copolymer. When the photoresist composition includes more than about 0.4% by weight of the surfactant, the application of the photoresist composition is blocked. When the photoresist composition includes less than about 0.05% by weight of surfactant, the surface leveling of a layer is deteriorated. Thus, the photoresist composition includes about 0.05 to about 0.4% by weight of the surfactant.

The photoresist composition may further include a coloring agent, a dying agent, a streation preventing agent, a plasticizer or an adhesion promoting agent.

Method of Forming Photoresist Pattern

A photoresist composition is applied to an underlying layer by a spinless coating method to form a photoresist pattern. The underlying layer may correspond to an insulation layer or a conductive layer. The insulation layer or the conductive layer may have a layer including silicon, polysilicon, aluminum, molybdenum, tantalum, copper, ceramic, aluminum/copper mixture, silicon oxide, doped silicon oxide, silicon nitride, indium tin oxide (ITO), indium zinc oxide (IZO) or polymeric resin.

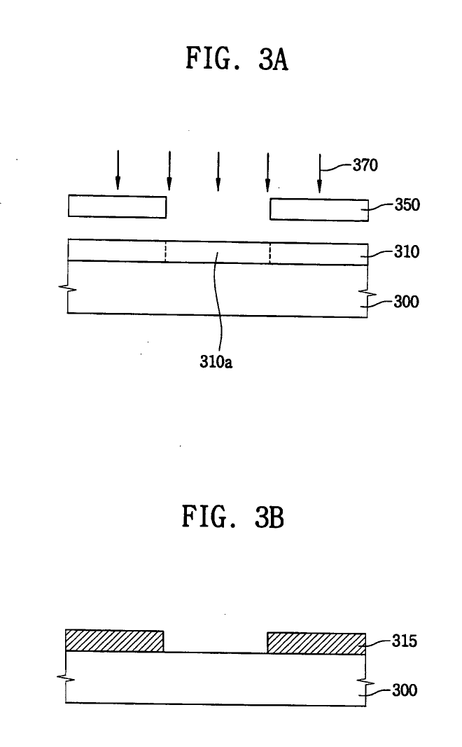

The method of forming the photoresist pattern is shown in FIGS. 3A and 3B.

FIGS. 3A and 3B are cross-sectional views illustrating the method of forming the photoresist pattern using the photoresist composition.

Referring to FIG. 3A, the photoresist composition is applied to a substrate 300. The photoresist composition includes a novolak resin having a weight average molecular weight of about 2,000 to about 15,000, a diazide based photosensitive compound and a volatile organic solvent. A spinless coater is used for coating the photoresist composition. The photoresist composition is baked at about 80 to about 130□ to evaporate the volatile organic solvent. This process is referred to as a soft baking process. In the soft baking process, the volatile organic solvent is evaporated without thermal decomposition of the novolak resin in the photoresist composition. The soft baking process cures the novolak resin by light. The thickness of the photoresist film 310 after evaporation of the volatile organic solvent is about 2 μm or less.

A mask 350 having a pattern is disposed over the photoresist film 310 to irradiate an ultraviolet (UV) lay 370 onto the photoresist film 310. The photoresist film 310 is partially exposed to the UV lay 370. The exposed portion of the photoresist film 310a undergoes a photochemical reaction to become soluble in a developing solution. This kind of photoresist composition is referred to as a positive photoresist composition.

The substrate 300 exposed to the UV ray 370 is dipped into an alkaline developing solution. Then, the exposed photoresist film 310a is dissolved in the developing solution. Examples of the alkaline developing solution include alkali metal hydroxides, ammonium hydroxides, tetramethyl ammonium hydroxides, etc.

The substrate 300 is then taken out of the developing solution and heated at a temperature of about 90 to about 140□ to enhance adhesion and chemical resistance of the photoresist film 310. This process is referred to as a ‘hard baking process’. The heat treatment is performed under a softening temperature of the photoresist film 310. If the heat treatment is carried out at or over the softening temperature of the photoresist film 310, the photoresist film 310 may collapse. Through this heat treatment, a photoresist pattern 315 is formed

The substrate 300 having the photoresist pattern 315 is treated with a corrosive solution or a plasma gas to etch away the region with no photoresist pattern 315. Then, the photoresist pattern 315 is stripped off by using a stripper to form a circuit pattern in the liquid crystal display apparatus.

Hereinafter, the present invention will be described in detail with reference to the following examples. The examples are given solely for the purpose of illustration and are not to be construed as limitations of the present invention, as many variations thereof are possible without departing from the spirit and scope of the invention.

Method of Forming Photoresist Composition and Photoresist film

### EXAMPLE 1

16.7 g of a novolak resin having a weight average molecular weight of 9,000, 3.3 g of a photosensitive compound, 0.15 g of a surfactant and 80 g of a volatile organic solvent were mixed at room temperature at a speed of 40 rpm to obtain a photoresist composition. The photosensitive compound is a mixture of 2,3,4,-trihydroxy benzophenone-1,2-naphthoquinone diazide-5-sulphonate and 2,3,4,4′-tetrahydroxy benzophenone-1,2-naphthoquinone diazide-5-sulphonate in a ratio of 5:5 by weight. The surfactant is polyoxyalkylene dimethylpolysiloxane, and the volatile organic solvent is a mixture of propylene glycol methyl ether acetate (PGMEA) and ethyl-p-ethoxypropionate (EEP) in a ratio of 90:10 by weight.

The viscosity of the photoresist composition was determined at 25□ using a Cannon-Fenske viscometer of Cannon Instrument Company of U.S.A. (150-762E). The viscosity of the photoresist composition was 5.00 cP.

The photoresist composition was applied to a glass substrate having a thickness of 0.7 mm by a slit coating method. The substrate was dried under reduced pressure and then heated at the temperature of 115□ for 90 seconds to obtain a photoresist film having a thickness of 1.50 μm.

### EXAMPLE 2

The same procedure as Example 1 was repeated except that a mixture of propylene glycol methyl ether acetate (PGMEA), ethyl-β-ethoxypropionate (EEP) and n-propyl acetate (nPAC) in a ratio of 80:10:10 by weight was used as the volatile organic solvent instead of the mixture of propylene glycol methyl ether acetate (PGMEA) and ethyl-β-ethoxypropionate (EEP) in a ratio of 90:10 by weight. A photoresist composition and a photoresist film were obtained. The viscosity of the photoresist composition was determined at 25□ using a Cannon-Fenske viscometer of Cannon Instrument Company of U.S.A. (150-762E). The viscosity of the photoresist composition was 4.61 cP.

### EXAMPLE 3

The same procedure as Example 1 was repeated except that a mixture of propylene glycol methyl ether acetate (PGMEA) and n-propyl acetate (nPAC) in ratio of 90:10 by weight was used as the volatile organic solvent instead of the mixture of propylene glycol methyl ether acetate (PGMEA) and ethyl-β-ethoxypropionate (EEP) in a ratio of 90:10 by weight. A photoresist composition and a photoresist film were obtained. The viscosity of the photoresist composition was determined at 25□ using a Cannon-Fenske viscometer of Cannon Instrument Company of U.S.A. (150-762E). The viscosity of the photoresist composition was 4.56 cP.

### EXAMPLE 4

The same procedure as Example 1 was repeated except that a mixture of propylene glycol methyl ether acetate (PGMEA) and n-butyl acetate (nBA) in ratio of 90:10 by weight was used as the volatile organic solvent instead of the mixture of propylene glycol methyl ether acetate (PGMEA) and ethyl-β-ethoxypropionate (EEP) in a ratio of 90:10 by weight. A photoresist composition and a photoresist film were obtained. The viscosity of the photoresist composition was determined at 25□ using a Cannon-Fenske viscometer of Cannon Instrument Company of U.S.A. (150-762E). The viscosity of the photoresist composition was 4.60 cP.

### COMPARATIVE EXAMPLE 1

The same procedure as Example 1 was repeated except that propylene glycol methyl ether acetate (PGMEA) was used alone as the volatile organic solvent instead of the mixture of propylene glycol methyl ether acetate (PGMEA) and ethyl-β-ethoxypropionate (EEP) in a ratio of 90:10 by weight. A photoresist composition and a photoresist film were obtained. The viscosity of the photoresist composition was determined at 25□ using a Cannon-Fenske viscometer of Cannon Instrument Company of U.S.A. (150-762E). The viscosity of the photoresist composition was 4.99 cP.

### COMPARATIVE EXAMPLE 2

The same procedure as Example 1 was repeated except that a mixture of propylene glycol methyl ether acetate (PGMEA) and γ-butyrolactone (GBL) in a ratio of 90:10 by weight was used as a volatile organic solvent instead of a mixture of propylene glycol methyl ether acetate (PGMEA) and ethyl-β-ethoxypropionate (EEP) in a ratio of 90:10 by weight. A photoresist composition and a photoresist film were obtained. The viscosity of the photoresist composition was determined at 25□ using a Cannon-Fenske viscometer of Cannon Instrument Company of U.S.A. (150-762E). The viscosity of the photoresist composition was 5.32 cP.

It is noticed from Examples 1 to 4 that the viscosity of solid content in the photoresist composition is preferably from 3.0 to 10.0 cP. By using of n-butyl acetate (nBA) or n-propyl acetate (nPAC) that has low viscosity (Examples 2 to 4), a photoresist composition that reduces the generation of blots during the coating method can be obtained.

Experiments

Each of the photoresist compositions obtained in Examples 1 to 4 and Comparative Examples 1 and 2 was coated on substrates having a chromium layer by a spinless coating method to form photoresist films. The properties of the photoresist films were tested using the following method. The results of the test are shown in Table 1 below.

1) Uniformity in Scanning Direction

A standard photoresist film having a thickness of 1.50 μm was prepared after soft baking at 115□ for 90 seconds. The photoresist films of Examples 1 to 4 and Comparative Examples 1 and 2 were soft baked. During a slit coating method, the thicknesses of the standard photoresist film and the photoresist films of Examples 1 to 4 and Comparative Examples 1 and 2 were determined at every scanning position and then compared. The results are shown in Table 1.

2) Thick Blot

A thick blot indicates a blot generated from the unevenness of the thickness of a photoresist film. The thick blot was evaluated by observing the existence of the thick blot and the quantity of the thick blot with naked eyes.

3) Small Resin Blot

A small resin blot was generated by residue of the resin in the photoresist composition on the substrate after formation of the photoresist film. The small resin blot was generated at the edge of the substrate in flow. The small resin blot was evaluated by observing the existence of the small resin blot and the quantity of the small resin blot with naked eyes. The result of the small resin blot is also shown in Table 1.

TABLE 1

| | | Layer condition | Layer condition |
|---|---|---|---|
| | Uniformity in | in view of | in view of small |
| | scanning | thick blot | resin blot |
| | direction (%) | Chromium layer | Chromium layer |
| Example 1 | 1.64 | ◯ | □ |
| Example 2 | 1.45 | □ | ◯ |
| Example 3 | 1.96 | ◯ | ◯□ |
| Example 4 | 1.82 | ◯ | ◯ |
| Comparative | 1.82 | ◯ | □ |
| Example 1 | | | |
| Comparative | 2.37 | X | □ |
| Example 2 | | | |

In Table 1, ‘□’ represents excellent, ‘◯’ represents good, ‘□’ represents bad, ‘X’ represents very bad, and ‘◯□’ represents ordinary.

As shown in Table 1, the photoresist films of Examples 1, 2 and 4 are more uniform than those of Comparative Examples 1 and 2. Moreover, less thick blots and less small resin blots are generated in the photoresist films of Examples 1, 2 and 4 than in Comparative Examples 1 and 2.

Combination of conventionally used propylene glycol methyl ether acetate (PGMEA) with ethyl-β-ethoxypropionate (EEP) that has good mobility or n-butyl acetate (nBA) or n-propyl acetate (nPAC) that has good volatility and low viscosity enhances mobility and coating characteristics of the photoresist composition. The photoresist composition may be applied to a large panel by a spinless coating method. Thus, a photoresist composition with few blots may be produced.

Above all, the photoresist composition of Example 2 shows excellent test results. The photoresist composition of Example 2 has 1.45% of uniformity in the scanning direction based on the thickness of the standard photoresist film, i.e., 1.50 μm. The photoresist composition of Example 2 also has few thick blots and few small resin blots. Thus, a mixture of a solvent that gives excellent residual layer characteristic such as propylene glycol methyl ether acetate (PGMEA), a solvent that gives excellent mobility such as ethyl-β-ethoxypropionate (EEP) and a solvent that gives excellent volatility such as n-butyl acetate (nBA) or n-propyl acetate (nPAC) as the volatile organic solvent mixture may provide a photoresist composition that can be used for coating a large display panel by a spinless coating method with a slit. The mixture also gives a photoresist composition that generates few blots and improves productivity.

Large resin blot is generated in a vertical shape when the resin in the photoresist composition remains on the display panel during the formation of the photoresist film. The cause of the large resin blot is the same as the cause of the small resin blot. Thus, the large resin blot may also be reduced by use of the photoresist composition according to the present invention.

The photoresist composition according to the present invention for a spinless coater and the method of forming the photoresist pattern has advantages below.

The photoresist composition according to the present invention includes a volatile solvent to enhance the evenness of the surface and to reduce blots. Thus, the errors that may be generated during the photolithography process are reduced and the photoresist composition may be used in a high pitch liquid crystal display apparatus. Moreover, the photoresist composition uses a spinless coating method when applied to a substrate. Thus, the photoresist composition according to the present invention may be used in a large substrate. The photoresist composition has an improved formulation and can be used in a large substrate and a high pitch liquid crystal display apparatus.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

1. A photoresist composition used for a spinless coater comprising:
a novolak resin having a weight average molecular weight of about 2,000 to about 15,000;
a diazide based photosensitive compound; and
a volatile organic solvent.

2. The photoresist composition of claim 1, wherein the photoresist composition comprises about 5 to about 30% by weight of the novolak resin, about 2 to about 10% by weight of the diazide based photosensitive compound and about 60 to about 90% by weight of the volatile organic solvent.

3. The photoresist composition of claim 1, wherein the diazide based photosensitive compound comprises a mixture of 2,3,4-trihydroxy benzophenone-1,2-naphthoquinone diazide-5-sulphonate and 2,3,4,4′-tetrahydroxy benzophenone-1,2-naphthoquinone diazide-5-sulphonate.

4. The photoresist composition of claim 3, wherein 2,3,4-trihydroxy benzophenone-1,2-naphthoquinone diazide-5-sulphonate and 2,3,4,4′-tetrahydroxy benzophenone-1,2-naphthoquinone diazide-5-sulphonate are mixed in a ratio of about 30:70 to about 70:30 by weight.

5. The photoresist composition of claim 1, wherein the volatile organic solvent comprises a first solvent selected from the group consisting of n-butyl acetate (nBA), n-propyl acetate (nPAC) and ethyl-β-ethoxypropionate (EEP) and a second solvent including propylene glycol methyl ether acetate (PGMEA).

6. The photoresist composition of claim 5, wherein the first solvent and the second solvent are mixed in a ratio of about 5:95 to about 50:50 by weight.

7. The photoresist composition of claim 1, wherein the volatile organic solvent comprises a first solvent selected from the group consisting of n-butyl acetate (nBA) and n-propyl acetate (nPAC), a second solvent including ethyl-β-ethoxypropionate (EEP) and a third solvent including propylene glycol methyl ether acetate (PGMEA).

8. The photoresist composition of claim 7, wherein the first solvent, the second solvent and the third solvent are mixed in a ratio of about 5˜25:5˜25:90˜50 by weight.

9. The photoresist composition of claim 1, further comprising a silicon based additive.

10. The photoresist composition of claim 9, wherein the silicon based additive comprises polyoxyalkylene dimethylpolysiloxane copolymer.

11. The photoresist composition of claim 10, wherein the silicon based additive is present in an amount of about 0.05 to about 0.4% by weight.

12. The photoresist composition of claim 1, wherein the photoresist composition has a viscosity of about 3.0 to about 10.0 cP.

13. The photoresist composition of claim 1, wherein photoresist composition is used for manufacturing a circuit for a liquid crystal display apparatus.

14. A method of forming a photoresist pattern comprising:
applying a photoresist composition for a spinless coater on an underlying layer by a spinless coating method to form a photoresist film, the photoresist composition including a novolak resin having a weight average molecular weight of about 2,000 to about 15,000, a diazide based photosensitive compound and a volatile organic solvent;
exposing the photoresist film; and
developing the exposed photoresist film to form a photoresist pattern.

15. The method of claim 14, wherein the underlying layer comprises at least one selected from the group consisting of silicon, polysilicon, aluminum, molybdenum, tantalum, copper, ceramic, aluminum/copper mixture, silicon oxide, doped silicon oxide, silicon nitride, indium tin oxide (ITO), indium zinc oxide (IZO) and polymeric resin.

16. The method of claim 14, wherein the photoresist composition is sprayed to the underlying layer through a slit type nozzle.

17. The method of claim 14, wherein the exposed photoresist film is developed using a developing solution including at least one selected form the group consisting of alkali metal hydroxides, ammonium hydroxides and tetramethylammonium hydroxides.
